(19) United States
(12) Patent Application Publication
(10) Pub. No.: US 2026/0070545 A1
(43) Pub. Date: Mar. 12, 2026

(54) PARKING ASSISTANCE DEVICE, PARKING ASSISTANCE METHOD, AND COMPUTER PROGRAM PRODUCT

(71) Applicants: DENSO CORPORATION, Kariya-city (JP); TOYOTA JIDOSHA KABUSHIKI KAISHA, Toyota-shi (JP); J-QuAD DYNAMICS Inc., Tokyo (JP)

(72) Inventors: Kazuma IWAZAWA, Tokyo (JP); Hiroki INAGAKI, Tokyo (JP); Daisuke SUZUKI, Okazaki-shi (JP); Takanori IMAZU, Anjo-shi (JP); Toshihiro TAKAGI, Nisshin-shi (JP)

(21) Appl. No.: 19/394,301

(22) Filed: Nov. 19, 2025

Related U.S. Application Data
(63) Continuation of application No. PCT/JP2024/018143, filed on May 16, 2024.

(30) Foreign Application Priority Data
May 24, 2023 (JP) 2023-085012

(51) Int. Cl. B60W 30/09; B60W 30/095; B60W 30/14

(52) U.S. Cl. CPC B60W 30/09; B60W 30/0956; B60W 30/143; B60W 2554/20; B60W 2554/4044; B60W 2554/4045

(57) ABSTRACT

A parking assistance device includes a route setting unit configured to set a target route by using a detection result of a sensor device, a control region setting unit configured to set a first control region and a second control region along the target route, and a driving control unit. The first control region is larger than the second control region. A center of the first control region is positioned farther from the vehicle than a center of the second control region. The driving control unit is configured to control driving of the vehicle such that a vehicle speed is kept at or below a threshold speed when an obstacle is detected within the first control region, and to control driving of the vehicle such that the vehicle is brought to a stop at a predefined deceleration when an obstacle is detected within the second control region.

### CROSS-REFERENCE TO RELATED APPLICATION

This application is a continuation application of International Application No. PCT/JP2024/018143 filed May 16, 2024 which designated the U.S. and claims priority to Japanese Patent Application No. 2023-085012 filed with the Japan Patent Office on May 24, 2023, the contents of each of which are incorporated herein by reference.

### BACKGROUND

### Technical Field

The present disclosure relates to a parking assistance device, a parking assistance method, and a computer program product.

### Related Art

Conventionally, parking assistance devices that assist in parking by guiding a vehicle to a target parking location have been proposed. For example, a parking assistance device has been known which, using detection results of sensors, detects whether an obstacle is present at a planned stop location along a guidance route, and, when an obstacle is present, modifies the planned stop location to a nearer location and controls the vehicle to stop at the modified planned stop location.

### BRIEF DESCRIPTION OF THE DRAWINGS

In the accompanying drawings:

FIG. 1 is a block diagram illustrating a schematic configuration of a parking assistance device according to one embodiment of the present disclosure;

FIG. 2 is an illustration of an example of a first control region and a second control region in the first embodiment;

FIG. 3 is an illustration of an example of a first control region and a second control region in the first embodiment;

FIG. 4 is a flowchart of a parking assistance process in the first embodiment;

FIG. 5 is a timing chart illustrating an example transition of a vehicle speed;

FIG. 6 is a timing chart illustrating an example transition of a vehicle speed;

FIG. 7 is a timing chart illustrating an example transition of a vehicle speed;

FIG. 8 is a block diagram illustrating a schematic configuration of a parking assistance device according to a second embodiment;

FIG. 9 is an illustration of an example of a first control region, a second control region, an expected first control region, and an expected second control region in the second embodiment;

FIG. 10 is a flowchart of a parking assistance process in the second embodiment;

FIG. 11 is a flowchart of a parking assistance process in a third embodiment;

FIG. 12 is the flowchart of the parking assistance process in the third embodiment; and

FIG. 13 is an illustration of an example of a first control region and a second control region in another embodiment.

### DESCRIPTION OF SPECIFIC EMBODIMENTS

In the known parking assistance device, as disclosed in JP 2021-62658 A, when an obstacle such as a person is present slightly away from a planned travel route (guidance route), modification of the stop location or reduction of the vehicle speed is not performed. Accordingly, there arises an issue that an occupant of the vehicle or a person present in the vicinity of the vehicle performing a parking operation may feel insecurity.

One aspect of the present disclosure provides a parking assistance device (100, 100a) for assisting parking of a vehicle equipped with a sensor device capable of detecting surroundings is provided. The parking assistance device includes:

a route setting unit configured to set a target route from a current location of the vehicle to a planned parking location by using a detection result of the sensor device;

a control region setting unit configured to set, according to a location of the vehicle, a first control region and a second control region each including at least a portion positioned on a travel direction side of the vehicle, along the target route; and

a driving control unit configured to control driving of the vehicle.

The first control region is larger than the second control region, a center of the first control region is positioned farther from the vehicle than a center of the second control region. The driving control unit is configured to control driving of the vehicle such that a vehicle speed of the vehicle is kept at or below a predefined threshold speed when an obstacle is detected within the first control region by the sensor device, and to control driving of the vehicle such that the vehicle is brought to a stop at a predefined deceleration when an obstacle is detected within the second control region by the sensor device.

According to the parking assistance device of this aspect, when an obstacle is detected within the first control region, which includes at least a portion positioned on the travel direction side of the vehicle and has its center positioned farther from the vehicle than the center of the second control region, driving of the vehicle is controlled such that the vehicle speed of the vehicle is kept at or below a predefined threshold speed. Accordingly, when a person is present slightly apart from the target route, insecurity felt by such a person and an occupant of the vehicle Va can be suppressed. In addition, when an obstacle is detected within the second control region having its center positioned closer to the vehicle than the center of the first control region, driving of the vehicle is controlled so as to bring the vehicle to a stop at a predefined deceleration. Therefore, when a person is present slightly apart from the target route but closer to the vehicle, insecurity felt by such a person and an occupant of the vehicle can be suppressed.

A. First Embodiment

A1. Device Configuration

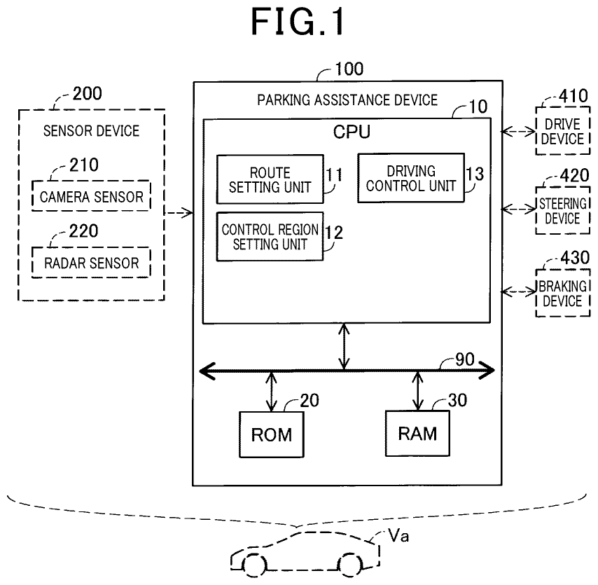

A parking assistance device 100 according to the embodiment illustrated in FIG. 1 is mounted to a vehicle Va for use. The parking assistance device 100 performs parking assistance for the vehicle Va. In such parking assistance, a target route from the vehicle Va to a planned parking location is set, and the vehicle Va is automatically driven along the target route from its current location. At this time, an upper limit of the vehicle speed of the vehicle Va is restricted to a predefined default speed. In the present embodiment, the “default speed” is 5 km/h (kilometres per hour). It should be noted that the default speed is not limited to 5 km/h, and any other speed may be set as the default speed.

The vehicle Va includes, in addition to the parking assistance device 100, a sensor device 200, a drive device 410, a steering device 420, and a braking device 430.

The sensor device 200 includes a group of sensors capable of detecting surroundings of the vehicle Va. Specifically, the sensor device 200 includes a camera sensor 210 and a radar sensor 220. The camera sensor 210 captures images of the surroundings of the vehicle Va and performs image processing on the captured image data to detect information around the vehicle Va, such as obstacles including other vehicles, pedestrians, and structures such as utility poles, as well as information about white lines and other markings. The camera sensor 210 detects obstacles and lane markings within a region with a lateral width along the travel direction of the vehicle Va. The term “travel direction of the vehicle Va” refers to the forward direction when the vehicle Va is moving forward, and to the backward direction when the vehicle Va is moving backward. The radar sensor 220 emits electromagnetic waves (radio waves or light) of a predefined wavelength and detects obstacles around the vehicle Va by using reflected waves received therefrom. As the radar sensor 220, for example, a millimeter-wave radar or a Light Detection and Ranging (LiDAR) may be used. In the case of the LiDAR, it emits light at a predefined wavelength while scanning, receives the reflected light, identifies the direction of each obstacle based on the position where the peak of the reflected wave is detected, and determines the distance to the obstacle using the time of flight (TOF) from light emission to reception of the reflected wave. The sensor device 200 notifies the parking assistance device 100 of the detection results. In the parking assistance device 100, various processes are performed in functional blocks (not shown) to acquire information used for driving assistance of the vehicle Va, such as identification of obstacles and detection of lane markings.

The drive device 410 is a group of devices for driving the vehicle Va. The drive device 410 includes a device such as an engine or a motor generator that generates drive force, various actuators for driving the engine or motor generator, and an electronic control unit (ECU) for controlling the actuators. The vehicle Va may be configured as any type of vehicle such as an engine vehicle, a hybrid vehicle (HEV), a plug-in hybrid vehicle (PHEV), an electric vehicle (EV), or a fuel cell vehicle (FCV, FCHV). The steering device 420 is a group of devices for steering the vehicle Va. The steering device 420 includes a steering wheel, a steering angle sensor, a hydraulic device for steering assistance, an actuator for generating hydraulic pressure, and an ECU for controlling steering. The braking device 430 is a group of devices for generating braking force on the vehicle Va. The braking device 430 includes a disc rotor, a brake pad, a hydraulic device for braking, an actuator for generating hydraulic pressure, and an ECU for controlling braking. The drive device 410, the steering device 420, and the braking device 430 each communicate with the parking assistance device 100. The parking assistance device 100 transmits control signals to the devices 410 to 430 and, conversely, receives signals from the devices 410 to 430 indicating their respective operating states. In the present embodiment, the “signals indicating the operating states” include signals indicating, for example, the vehicle speed of the vehicle Va, whether a brake is operated, whether a direction indicator is operated, an amount of wheel rotation, and a steering amount.

In this embodiment, the parking assistance device 100 includes an ECU configured such that a CPU 10, a ROM 20, and a RAM 30 are communicable with each other via an internal bus 90. The ROM 20 includes a non-volatile memory such as an EEPROM and stores, in advance, a control program. The CPU 10 functions as a route setting unit 11, a control region setting unit 12, and a driving control unit 13 by loading and executing the control program in the RAM 30.

The route setting unit 11 sets a target route to a planned parking location of the vehicle Va by utilizing a detection result of the sensor device 200. For example, when the vehicle Va is stopped near a parking slot in which the vehicle is to be parked, and when the driver of the vehicle Va instructs performance of parking assistance through a user interface (not illustrated), the route setting unit 11 causes a display device (not illustrated) to display detected parking slots by utilizing a captured image from the camera sensor 210 and information on surrounding targets acquired by the radar sensor 220. Then, when the driver selects and designates, as a planned parking location, one of the detected parking slots in which the vehicle is to be parked through the user interface, the route setting unit 11 sets a route from the current location of the vehicle Va to the center position of the designated parking slot as a target route. The method of setting the target route may be any other arbitrary method. For example, in cases where a predefined parking location exists, such as a garage at home, and its latitude and longitude are pre-stored in ROM 20, the route setting unit 11 may acquire the current location (latitude and longitude) of the vehicle Va by a Global Positioning System (GPS) or the like, and set a route from the current location to the predefined parking location as the target route.

The control region setting unit 12 sets a first control region and a second control region around the vehicle Va. Both the first control region and the second control region are used as regions for determining the presence or absence of an obstacle in a parking assistance process described later.

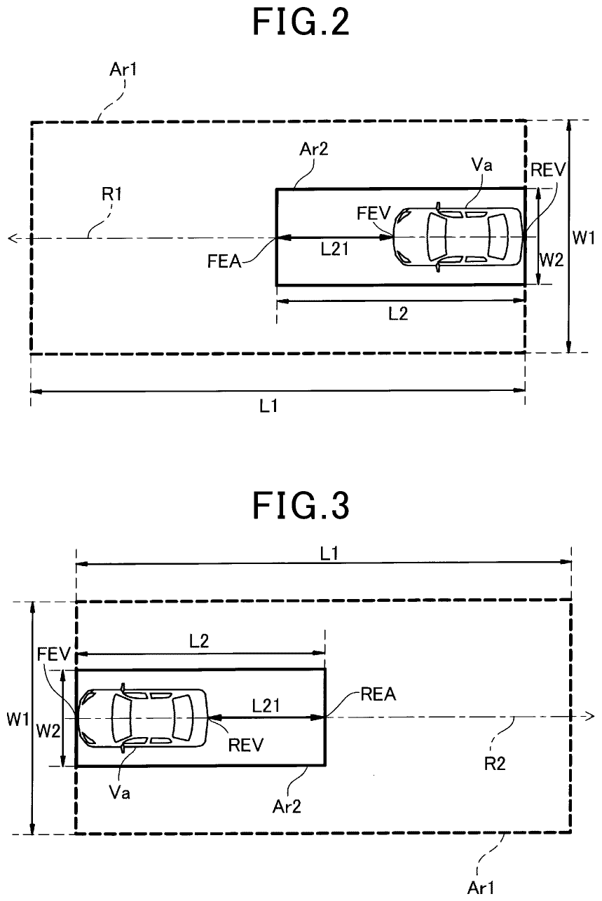

FIG. 2 illustrates a first control region Ar1 and a second control region Ar2 that are set when the vehicle Va moves forward. Both the first control region Ar1 and the second control region Ar2 are rectangular regions, in each of which a longitudinal direction coincides with the longitudinal direction of the vehicle Va and a lateral direction coincides with the vehicle width direction of the vehicle Va. The longitudinal direction of the vehicle Va is a direction along a target route R1. In the example illustrated in FIG. 2, the rear end of the first control region Ar1 in the forward travel direction and the rear end of the second control region Ar2 in the forward travel direction both coincide with the rear end REV of the vehicle in the forward travel direction.

FIG. 3 illustrates a first control region Ar1 and a second control region Ar2 that are set when the vehicle Va moves backward. The shapes and sizes of the first control region Ar1 and the second control region Ar2 are the same as those of the first control region Ar1 and the second control region Ar2 illustrated in FIG. 2. The longitudinal direction of the vehicle Va is a direction along a target route R2. In the example illustrated in FIG. 3, the rear end of the first control region Ar1 in the backward travel direction and the rear end of the second control region Ar2 in the backward travel direction both coincide with the rear end FEV of the vehicle Va in the backward travel direction.

Both the first control region Ar1 and the second control region Ar2 are regions including the vehicle Va on their rear-end sides. Each of the first control region Ar1 and the second control region Ar2 include a portion of the region positioned on the travel direction side of the vehicle Va, (the forward side in the example of FIG. 2, and the backward side in the example of FIG. 3). The first control region Ar1 is larger than the second control region Ar2. A center position of the first control region Ar1 is farther from the vehicle Va than a center position of the second control region Ar2. In the present embodiment, a longitudinal length L1 of the first control region Ar1 is 20 m (meters). A lateral length W1 of the first control region Ar1 is 12 m. A longitudinal length L2 of the second control region Ar2 is 12 m. A lateral length W2 of the second control region Ar2 is 5 m. The above lengths L1, L2, W1, and W2 are merely examples, and may be appropriately modified so long as the relative positional relationship and size relationship between the first control region Ar1 and the second control region Ar2 are not changed.

As illustrated in FIG. 2, when the vehicle Va moves forward, a space having a length L21 along the target route R1 is provided between a front-end portion FEA of the second control region Ar2 in the travel direction and a front-end portion FEV of the vehicle Va in the travel direction. Similarly, as illustrated in FIG. 3, when the vehicle Va moves backward, a space having a length L21 along the target route R2 is provided between a rear-end portion REA of the second control region Ar2 in the travel direction and a rear-end portion REV of the vehicle Va in the travel direction. Details of the length L21 will be described later.

When the power supply of the parking assistance device 100 is turned on, the control region setting unit 12 repeatedly sets the first control region Ar1 and the second control region Ar2. Accordingly, while the vehicle Va is moving, the positions of the first control region Ar1 and the second control region Ar2 move together with the vehicle Va.

The driving control unit 13 illustrated in FIG. 1 controls driving of the vehicle Va. Specifically, the driving control unit 13 controls the drive device 410, the steering device 420, and the braking device 430 in accordance with detection results of the sensor device 200 and driver's operations a steering wheel, an accelerator pedal, a brake pedal, or the like.

### A2. Parking Assistance Process

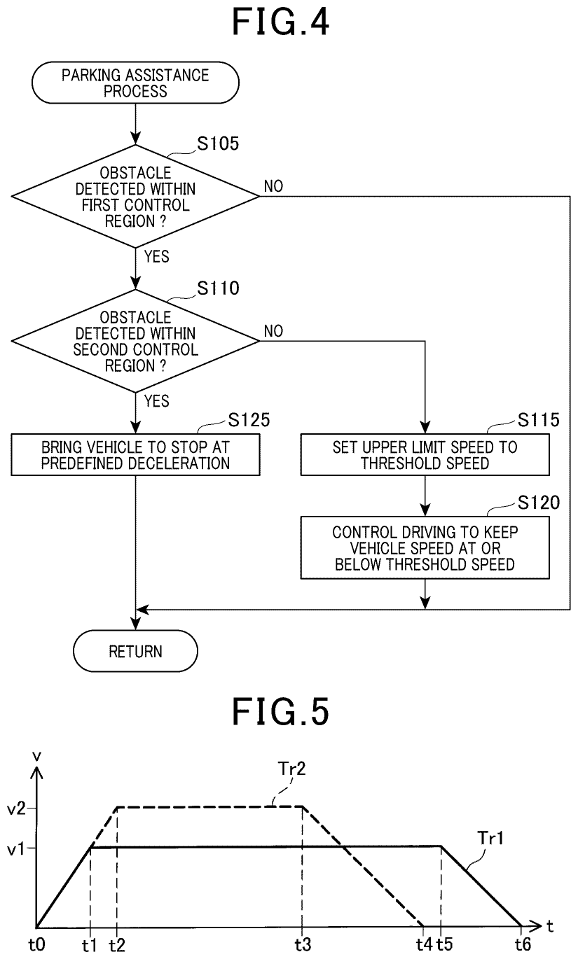

A parking assistance process illustrated in FIG. 4 is a process for assisting parking of the vehicle Va. When an occupant of the vehicle Va instructs performance of parking assistance through a specific user interface provided in the vehicle Va, setting of the target route is performed. Upon completion of setting of the target route, the parking assistance process illustrated in FIG. 4 is performed. It the term “specific user interface” in the present embodiment refers to a menu screen displayed on a display having a touch panel function mounted to the vehicle Va. As an alternative to such a menu screen, any interface operable by the occupant of the vehicle Va may be used, such as a menu screen of an application preinstalled on a smartphone possessed by the occupant, a button provided on a smart key device for the vehicle Va, or a physical switch provided on an instrument panel of the vehicle Va.

The driving control unit 13 determines whether an obstacle has been detected by the sensor device 200 within the first control region Ar1 (step S105). If no obstacle has been detected within the first control region Ar1 (step S105: NO), the process flow returns to step S105.

If an obstacle has been detected within the first control region Ar1 (step S105: YES), the driving control unit 13 determines whether an obstacle has been detected within the second control region Ar2 (step S110). If no obstacle has been detected within the second control region Ar2 (step S110: NO), the driving control unit 13 sets an upper limit speed to a threshold speed (step S115). The threshold speed at step S115 is a speed lower than a default speed. Specifically, in the present embodiment, the threshold speed is set to 3 km/h.

The driving control unit 13 controls driving of the vehicle Va to keep the speed of vehicle Va at or below the threshold speed (step S120).

FIG. 5 illustrates a transition of the speed of the vehicle Va when steps S115 and S120 are performed during acceleration. In FIG. 5, the horizontal axis represents time t, and the vertical axis represents the speed v of the vehicle Va (hereinafter also simply referred to as “vehicle speed”). In FIG. 5, a transition Tr1 indicated by the bold solid line represents a transition of the vehicle speed when an obstacle is detected within the first control region Ar1 but outside the second control region Ar2. A transition Tr2 indicated by the bold broken line represents a transition of the vehicle speed when no obstacle is detected within the first control region Ar1, that is, when no obstacle is detected within the second control region Ar2 either.

For example, when performance of the parking assistance process is instructed at time t0 at which the vehicle is stationary, and an obstacle such as a person is detected within the first control region Ar1, step S115 is performed, and as indicated by the transition Tr1, the upper limit speed is reduced from the default speed v2 to the threshold speed v1. Therefore, when the vehicle speed v reaches the threshold speed v1 at time t1, the vehicle speed v ceases to increase and keep the vehicle speed at the threshold speed v1. Subsequently, when the vehicle reaches a deceleration point on the target route at time t5, the vehicle speed v decreases and becomes zero at time t6.

In contrast, when performance of the parking assistance process is instructed at a time t0 at which the vehicle is stationary and no obstacle such as a person is detected within the first control region Ar1, acceleration continues even after time t1, and when the vehicle speed v reaches the default speed v2 at time t2, acceleration ceases and the vehicle speed v is kept at the default speed v2. Subsequently, when the vehicle reaches the deceleration point on the target route at time t3, the vehicle speed v decreases and becomes zero at time t4.

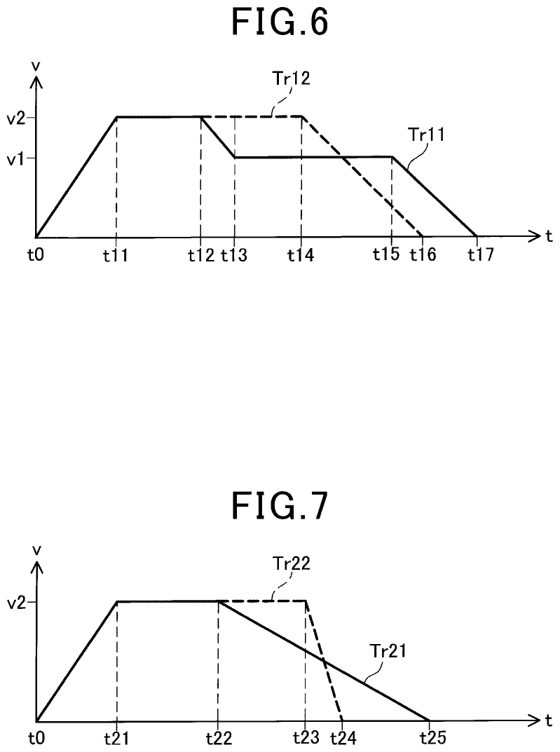

FIG. 6 illustrates a transition of the speed of the vehicle Va when steps S115 and S120 are performed while the vehicle Va is traveling at the default speed v2. The vertical and horizontal axes in FIG. 6 are the same as those in FIG. 5. In FIG. 6, a transition Tr11 indicated by the bold solid line represents a transition of the vehicle speed when an obstacle is detected within the first control region Ar1 but outside the second control region Ar2. A transition Tr12 indicated by the bold broken line represents a transition of the vehicle speed when no obstacle is detected within the first control region Ar1, that is, when no obstacle is detected within the second control region Ar2 either. For example, after the vehicle speed v reaches the vehicle speed v2 at time t11, when an obstacle is detected at time t12 and step S115 is performed, causing the upper limit speed to be reduced from the default speed v2 to the threshold speed v1, performance of step S120 causes the vehicle speed v to decrease from the default speed v2 toward the threshold speed v1. Subsequently, when the vehicle speed v reaches the threshold speed v1 at time t13, the driving control unit 13 controls driving of the vehicle such that the vehicle speed is kept at the threshold speed v1. When the vehicle reaches the deceleration point on the target route at time t15, the vehicle speed v decreases and becomes zero at time t17.

In contrast, when no obstacle is detected within the first control region Ar1, as indicated by the transition Tr12, the vehicle Va continues traveling at the default speed v2, and when the vehicle reaches the deceleration point on the target route at time t14, the vehicle speed v decreases and becomes zero at time t16.

As described with reference to FIGS. 5 and 6, when an obstacle is detected within the first control region Ar1 but outside the second control region Ar2, the upper limit of the vehicle speed is reduced from the predefined default speed v2 to the threshold speed v1, and driving of the vehicle Va is controlled such that the vehicle speed is kept at or below the threshold speed v1. This can suppress insecurity felt by the occupant of the vehicle Va. In addition, when the obstacle is a person, it is also possible to suppress insecurity felt by such a person.

As illustrated in FIG. 4, when it is determined that an obstacle has been detected within the second control region (step S110: YES), the driving control unit 13 brings the vehicle Va to a stop at a predefined deceleration (step S125). The deceleration at step S125 is lower than the deceleration after the vehicle Va reaches the deceleration point, that is, lower than any of the deceleration between times t5 to t6 and the deceleration between times t3 to t4 in FIG. 5, and the deceleration between times t15 to t17 and the deceleration between times t14 to t16 in FIG. 6.

In FIG. 7, the bold solid line indicates a transition Tr21 of the vehicle speed when step S125 is performed while the vehicle Va is traveling at the default speed v2. In FIG. 7, the bold broken line indicates a transition Tr22 of the vehicle speed in a comparative example. In the comparative example, the vehicle is brought to a stop when an obstacle is detected on the target route and in the vicinity of the vehicle.

As indicated by the transition Tr21, after the vehicle speed v reaches the vehicle speed v2 at time t21, when an obstacle is detected within the second control region Ar2 at time t22 while the vehicle Va is traveling at the default speed v2, the driving control unit 13 initiates a relatively gradual deceleration and brings the vehicle Va to a stop at time t25.

In contrast, in the comparative example, when an obstacle is detected on the target route and in the vicinity of the vehicle at time t23, the vehicle is abruptly braked and brought to a stop at time t24. Accordingly, the occupant of the vehicle may feel insecurity due to the sudden braking. When the obstacle is a person, the vehicle approaches such a person at a relatively high speed, which may cause the person to feel insecurity. On the other hand, in the present embodiment, the vehicle speed is reduced relatively gradually starting from earlier time t22, which can suppress insecurity felt by both the occupant of the vehicle Va and the person serving as the obstacle.

As illustrated in FIG. 4, after completion of step S125, after completion of step S120, or when it is determined at step S105 that no obstacle has been detected within the first control region (step S105: NO), the process flow returns to step S105.

As described above with reference to FIGS. 2 and 3, a space having a length L21 along the target route is provided in the travel direction of the vehicle Va within the second control region Ar2. In the present embodiment, the length L21 is defined as a distance equal to a braking distance when the vehicle travels at a predefined maximum speed along the target route, that is, when traveling at the default speed. For example, when the braking distance at the default speed of 5 km/h is 6 m, the length L21 is set to 6 m. Accordingly, in the example of FIG. 2, when an obstacle is detected in the vicinity of the front end FEA of the second control region Ar2, it is possible to inhibit the vehicle Va from colliding with such an obstacle. It should be noted that the length L21 is not limited to the braking distance and may be a distance longer than the braking distance.

According to the parking assistance device 100 of the first embodiment described above, when an obstacle is detected within the first control region Ar1, which includes at least a portion positioned on the travel direction side of the vehicle Va and has its center positioned farther from the vehicle Va than the center of the second control region Ar2, driving of the vehicle Va is controlled such that the vehicle speed of the vehicle Va is kept at or below a predefined threshold speed. Accordingly, when a person is present slightly apart from the target route R1, insecurity felt by such a person and an occupant of the vehicle Va can be suppressed. In addition, when an obstacle is detected within the second control region Ar2 having its center positioned closer to the vehicle Va than the center of the first control region Ar1, driving of the vehicle Va is controlled so as to bring the vehicle Va to a stop at a predefined deceleration. Therefore, when a person is present slightly apart from the target route R1 or R2 but closer to the vehicle Va, insecurity felt by such a person and an occupant of the vehicle Va can be suppressed.

Furthermore, the length L21 along the target route R1 from the front end FEA of the second control region Ar2 in the travel direction of the vehicle Va to the front end FEV of the vehicle Va in the travel direction (or the length L21 along the target route R2 from the rear end REA of the second control region Ar2 to the rear end REV of the vehicle Va) is set to a distance equal to or greater than a braking distance required when the vehicle Va travels at a predefined maximum speed (default speed) along the target route R1 (or R2). Accordingly, when an obstacle is detected near the boundary of the second control region Ar2, a collision of the vehicle Va with the obstacle can be inhibited.

### B. Second Embodiment

### B1. Device Configuration

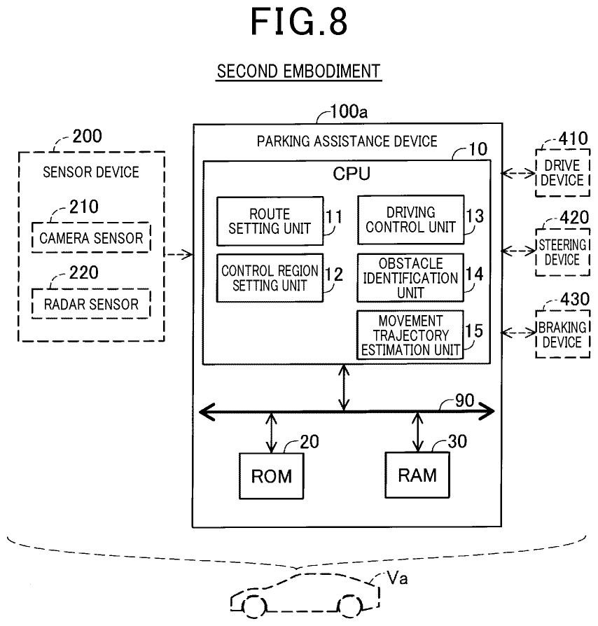

A parking assistance device 100a according to the second embodiment illustrated in FIG. 8 differs from the parking assistance device 100 of the first embodiment illustrated in FIG. 1 in that the CPU 10 also functions as an obstacle identification unit 14 and a movement trajectory estimation unit 15. Since the other components of the parking assistance device 100a are the same as those of the parking assistance device 100, the same reference numerals are assigned to the same components, and detailed descriptions thereof will be omitted. Like the other functional blocks 11 to 14, the obstacle identification unit 14 and the movement trajectory estimation unit 15 are implemented by the CPU 10 executing a control program stored in the ROM 20 after loading it into the RAM 30.

The obstacle identification unit 14 identifies whether an obstacle detected by the sensor device 200 is a stationary object or a moving object by utilizing a plurality of detection results acquired at different times by the sensor device 200. Specifically, when the same obstacle as that detected previously is detected again, and the position of the obstacle differs between the previous detection and the current detection, the obstacle is identified as a moving object.

The movement trajectory estimation unit 15 estimates a future movement trajectory of an obstacle identified as a moving object by the obstacle identification unit 14. Such estimation is performed by identifying a movement direction and a movement speed of the obstacle based on a history of positions of the detected obstacle (the history including position information of the obstacle detected previously and information relating to detection times), and estimating, based on this information, the position of the obstacle to be detected in a subsequent detection. Estimation of the movement trajectory of the obstacle is not limited to the above-described method, and may be implemented by any method utilizing detection results of the sensor device 200.

In the present embodiment, the control region setting unit 12 sets, in addition to the first control region and second control region, an expected first control region and an expected second control region.

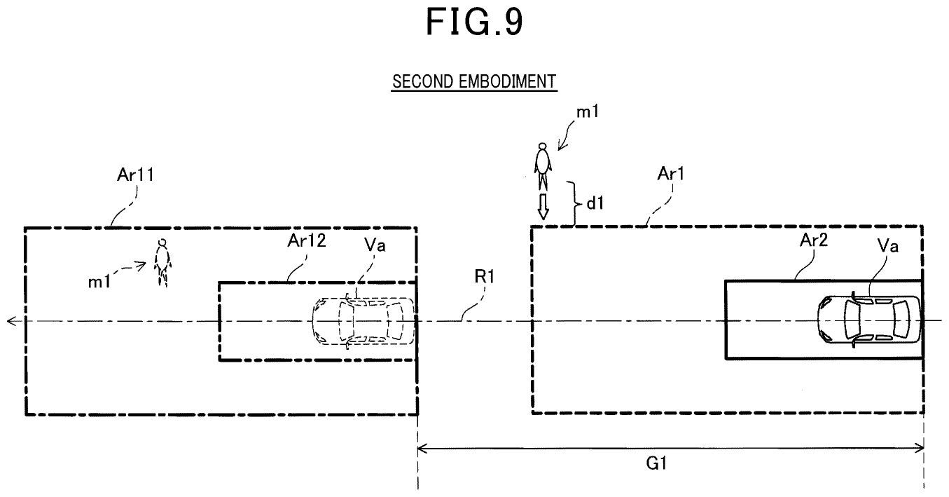

As illustrated in FIG. 9, an expected first control region Ar11 and an expected second control region Ar12 are set forward of the first control region Ar1 and the second control region Ar2 in the travel direction of the vehicle Va. The shape and size of the expected first control region Ar11 are the same as those of the first control region Ar1. The shape and size of the expected second control region Ar12 are the same as those of the second control region Ar2. In the present embodiment, there is provided a gap G1 of a predefined dimension along the travel direction (target route R1) between the position of the first control region Ar1 and the position of the expected first control region Ar11. In the present embodiment, the dimension of the gap G1 is set in advance by experiments or simulations as a distance such that, when a person m1 located at a predefined distance d1 away from the first control region Ar1 at a certain time walks toward the vehicle Va at a predefined walking speed, the person will be present within the first control region Ar1 at the next detection timing. The predefined distance d1 may be, for example, 2 m. The predefined walking speed may be, for example, 2.5 km/h.

### B2. Parking Assistance Process

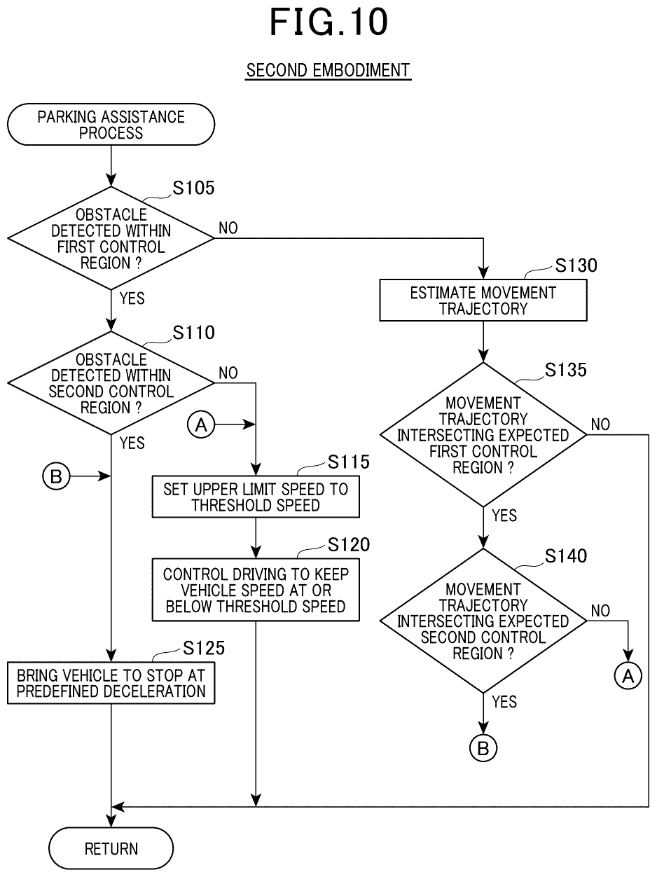

A parking assistance process according to the second embodiment illustrated in FIG. 10 differs from the parking assistance process of the first embodiment illustrated in FIG. 4 in that additional steps S130, S135, and S140 are performed. Since the other steps of the parking assistance process in the second embodiment are the same as those in the first embodiment, the same reference numerals are assigned to the same steps, and detailed descriptions thereof will be omitted.

If it is determined at step S105 that no obstacle has been detected within the first control region (step S105: NO), the movement trajectory estimation unit 15 estimates a movement trajectory of a moving object among obstacles detected outside the first control region (step S130). The driving control unit 13 determines whether the movement trajectory estimated at step S130 intersects the expected first control region Ar11 (step S135). If it is determined that the movement trajectory intersects the expected first control region Ar11 (step S135: YES), the driving control unit 13 determines whether the movement trajectory estimated at step S130 intersects the expected second control region Ar12 (step S140). The phrase “the movement trajectory intersects control regions (the expected first control region Ar11 and the expected second control region Ar12)”means that the movement trajectory intersects a boundary line of each control region.

If it is determined that the movement trajectory does not intersect the expected second control region Ar12 (step S140: NO), that is, if the movement trajectory intersects a boundary of the expected first control region Ar11 but does not intersect a boundary of the expected second control region Ar12, steps S115 and S120 are performed. In this case, driving of the vehicle Va is controlled such that the vehicle speed kept at or below the threshold speed.

In contrast, if it is determined that the movement trajectory intersects the expected second control region Ar12 (step S140: YES), that is, if the movement trajectory intersects both a boundary of the expected first control region Ar11 and a boundary of the expected second control region Ar12, step S125 is performed. In this case, the vehicle Va decelerates at a predefined deceleration and comes to a stop.

If it is determined at step S135 that the movement trajectory does not intersect the expected first control region Ar11, the process flow returns to step S105. If it is determined at step S140 that the movement trajectory does not intersect the expected second control region Ar12, the process flow proceeds to step S115.

The parking assistance device 100a of the second embodiment described above provides the same effects as the parking assistance device 100 of the first embodiment. In addition, whether a detected obstacle is a stationary object or a moving object is determined, and a future movement trajectory of the moving object is estimated. Driving of the vehicle Va is then controlled such that the vehicle speed is kept at or below the threshold speed when the movement trajectory intersects the expected first control region Ar11, and the vehicle Va is controlled to come to a stop at a predefined deceleration when the movement trajectory intersects the expected second control region Ar12. This configuration allows the vehicle Va to be controlled in anticipation of the future movement of the obstacle. Therefore, insecurity felt by a person serving as a moving object located farther from the target route R1 can be suppressed, and insecurity felt by an occupant of the vehicle Va can be further suppressed.

### C. Third Embodiment

Since the configuration of the parking assistance device 100 according to a third embodiment is the same as the configuration of the parking assistance device 100 according to the first embodiment, the same reference numerals are assigned to the same components, and detailed descriptions thereof will be omitted.

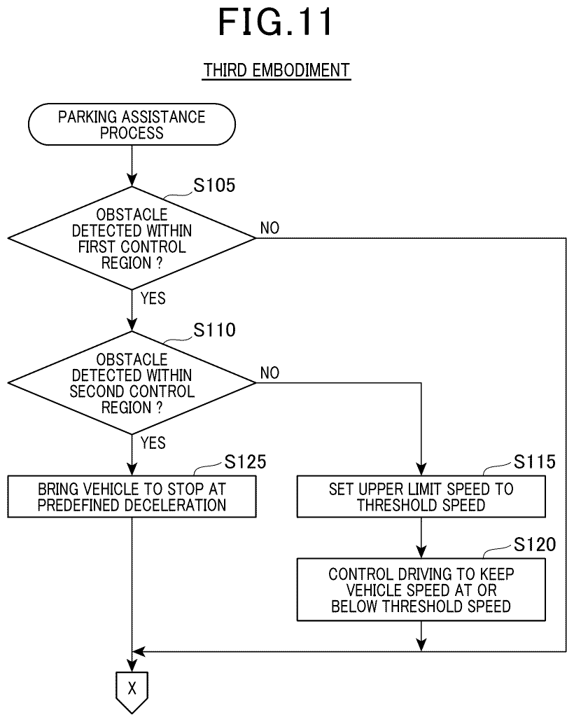

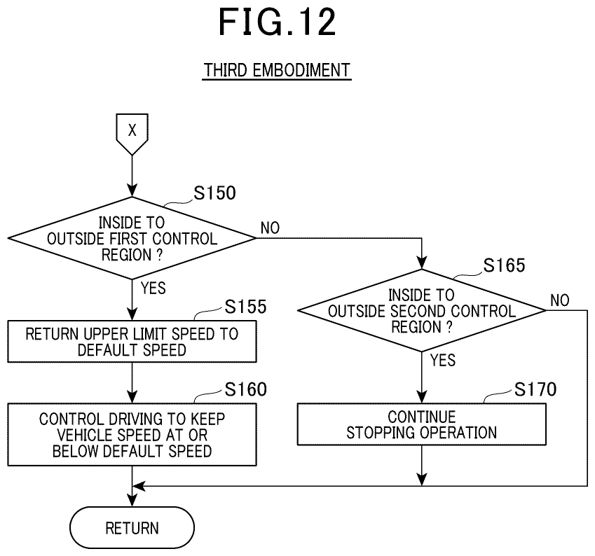

A parking assistance process according to the third embodiment illustrated in FIGS. 11 and 12 differs from the parking assistance process of the first embodiment illustrated in FIG. 4 in that, after completion of any of step S120 and step S125, the process flow does not return to step S105 but instead performs steps S150 to S170 illustrated in FIG. 12. Since the other steps of the parking assistance process in the third embodiment are the same as those in the first embodiment, the same reference numerals are assigned to the same steps, and detailed descriptions thereof will be omitted.

As illustrated in FIGS. 11 and 12, after completion of any of steps S120 and S125, the driving control unit 13 determines, based on detection results of the sensor device 200, whether a detected obstacle has moved from inside the first control region Ar1 to outside the first control region Ar1 (step S150).

If it is determined that a detected obstacle has moved from inside the first control region Ar1 to outside the first control region Ar1 (step S150: YES), the driving control unit 13 resets the upper limit speed to the default speed (step S155). The driving control unit 13 controls driving such that the vehicle speed is kept at or below the default speed (step S160). For example, when step S155 is completed while the vehicle Va is traveling at the threshold speed and no acceleration request occurs thereafter, the vehicle Va continues traveling while keeping the threshold speed. On the other hand, for example, if step S155 is completed while the vehicle Va is traveling at the threshold speed and an acceleration request occurs thereafter, acceleration of the vehicle Va is performed, and the vehicle speed increases beyond the threshold speed (3 km/h) up to the default speed (5 km/h) as an upper limit. After performance of step S160, the process flow returns to step S105 in FIG. 11. When an obstacle moves from inside to outside the first control region Ar1 whose boundary is relatively far from the vehicle Va, the likelihood that the obstacle will approach the immediate vicinity of or collide with the vehicle Va in the future is low. Thus, in this case, resetting the upper limit speed to the default speed can inhibit a time required for the parking operation from being unnecessarily prolonged.

On the other hand, if it is determined that the detected obstacle has not moved from inside the first control region Ar1 to outside the first control region Ar1 (step S150: NO), the driving control unit 13 determines whether the detected obstacle has moved from inside the second control region Ar2 to outside the second control region Ar2 (step S165).

If it is determined that the detected obstacle has moved from inside the second control region Ar2 to outside the second control region Ar2 (step S165: YES), the driving control unit 13 continues bringing the vehicle to a stop (step S170). When the vehicle Va is present within the second control region Ar2, step S125 described above is performed, and the driving control unit 13 attempts to decelerate the vehicle Va at a predefined deceleration to bring it to a stop. Since step S170 means continuation of this operation, the driving control unit 13 does not substantially perform any new operation at step S170. In contrast, if it is determined that the detected obstacle has not moved from inside the second control region Ar2 to outside the second control region Ar2 (step S165: NO), the process flow returns to step S105 in FIG. 11. In this case, as long as the obstacle remains within the second control region Ar2, steps S105, S110, and S125 shown in FIG. 11 are performed in this order, and the vehicle Va decelerates at a predefined deceleration and comes to a stop. Thus, even in this case, the driving control unit 13 does not substantially perform any new operation. Even when an obstacle moves from inside to outside the second control region Ar2 whose boundary is relatively close to the vehicle Va, the likelihood remains high that the obstacle will approach the vicinity of or collide with the vehicle Va in the future. Therefore, continuing deceleration of the vehicle Va at a predefined deceleration to bring it to a stop can inhibit the vehicle Va from alternating between performing and not performing the stopping operation when an obstacle detected outside the second control region is detected again within the second control region. Unpredictable behaviors that occur when the vehicle alternates between performing and not performing the stopping operation may cause insecurity to be felt by the occupant of the vehicle Va and insecurity to be felt by persons present around the vehicle Va. In the present embodiment, such insecurity felt by both the occupant and persons present around the vehicle Va can be suppressed.

According to the parking assistance device 100 of the third embodiment described above, the same effects as those of the parking assistance device 100 of the first embodiment can be achieved. In addition, the driving control unit 13 ceases controlling driving of the vehicle such that the vehicle speed is kept at or below the threshold speed when, after an obstacle is detected within the first control region Ar1, the obstacle is subsequently detected outside the first control region Ar1, which can inhibit the vehicle speed from being unnecessarily limited despite no collision with the obstacle being expected, thereby inhibiting the parking operation from taking an unnecessarily long time.

Once an obstacle has been detected within the second control region Ar2, which is a region positioned closer to the vehicle Va than the first control region Ar1, there remains a high likelihood that the obstacle will be detected again within the second control region Ar2 even if it is subsequently detected outside the second control region Ar2. According to the parking assistance device 100 of the third embodiment, when an obstacle is detected outside the second control region Ar2 after being detected within the second control region Ar2, the driving control unit 13 continues controlling driving of the vehicle Va by decelerating the vehicle Va at a predefined deceleration to bring it to a stop. This can inhibit the vehicle Va from alternating between performing and not performing the stopping operation when an obstacle detected outside the second control region is detected again within the second control region. Therefore, it is possible to suppress insecurity felt by the occupant of the vehicle Va and by persons present around the vehicle Va due to repeated performance and cessation of such a stopping operation.

### D. Other Embodiments

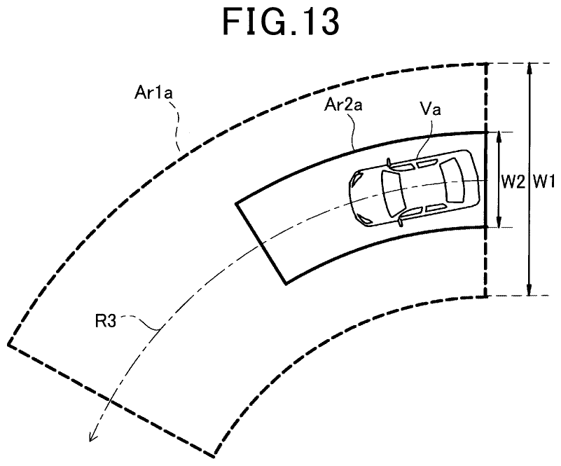

(D1) In each of the embodiments described above, the first control region Ar1 and the second control region Ar2 are rectangular regions. However, the present disclosure is not limited thereto. The control regions may alternatively be fan-shaped regions having the installation position of the sensor device 200 of the vehicle Va as an apex, or circular regions centered on the vehicle Va. Further, as illustrated in FIG. 13, in a case where at least a part of a target route R3 is arcuate along a road, first and second control regions Ar1a and Ar2a, which are set while the vehicle Va is traveling and turning along the arcuate portion, may have shapes along the target route R3. The expected first control region Ar11 and the expected second control region Ar12 may likewise have any arbitrary shape.

(D2) In the second embodiment, the expected first and second control regions Ar11 and Ar12 are set, and the upper limit speed is restricted or the vehicle Va is decelerated and stopped in anticipation of a future approach between the vehicle Va and an obstacle (moving object), depending on whether the movement trajectory of the moving object intersects any of these control regions Ar11 and Ar12. However, the present disclosure is not limited thereto. In an alternative, the vehicle Va may include, in addition to the parking assistance device 100 or 100a, a control device for controlling a collision-avoidance safety function (hereinafter referred to as a “safety assistance control device”). In a configuration in which the safety assistance control device detects (predicts) whether a collision between a moving object and the vehicle will occur in the future and the predicted time of such collision, the parking assistance devices 100 and 100a receive such a prediction result. In response to the prediction result indicating that a collision will occur, the upper-limit speed may be immediately restricted, or alternatively, the vehicle Va may be decelerated and brought to a stop at a timing that precedes the predicted time of collision by a predefined period. Even with such a configuration, the same effects as those of the second embodiment can be achieved. The “collision-avoidance safety function” set forth above refers to a function that, for example, automatically performs steering or braking to avoid a collision between the vehicle Va and an obstacle in response to such a collision being predicted, warns the occupant by turning on a predefined lamp or outputting an alert sound, or automatically increases the seatbelt tension to inhibit the occupant from being thrown into the cabin.

(D3) In the third embodiment, when a moving object moves from inside to outside the first control region Ar1, the upper limit speed is returned to the default speed and driving is controlled such that the vehicle speed is kept at or below the default speed. When a moving object moves from inside to outside the second control region Ar2, the stopping operation of the vehicle Va is continued. However, the present disclosure is not limited thereto. In an alternative, even when a moving object moves from inside to outside the first control region Ar1, the threshold speed may be left at the upper limit speed. Further, when a moving object moves from inside to outside of the second control region Ar2, the stopping operation of the vehicle Va may be ceased, and the process flow may return to step S105.

(D4) In each of the embodiments, only a portion of each of the first control regions Ar1, Ar1a and the second control regions Ar2, Ar2a is positioned on the travel direction side of the vehicle Va. However, the present disclosure is not limited thereto. In an alternative, the entirety of each of the first control regions Ar1 and Ar1a and each of the second control regions Ar2 and Ar2a may be positioned on the travel direction side of the vehicle Va. Even with such a configuration, the same effects as those of the respective embodiments can be achieved.

(D5) In each of the embodiments, the deceleration at step S125 is lower than the deceleration when a deceleration point on the target route is reached. However, the present disclosure is not limited thereto. In an alternative, the deceleration at step S125 may be equal to or higher than the deceleration when a deceleration point on the target route is reached. Even in this case, by satisfying the condition that the deceleration is lower than the deceleration when an obstacle is detected on the target route and in the vicinity of the vehicle in the comparative example, the same effects as those of the respective embodiments can be achieved.

(D6) The parking assistance device 100, 100a and the method thereof described in the present disclosure may be realized by a dedicated computer provided by configuring a processor and memory programmed to perform one or more functions embodied in a computer program. Alternatively, the parking assistance device 100, 100a and the method thereof described in the present disclosure may be realized by a dedicated computer provided by configuring a processor with one or more dedicated hardware logic circuits. Alternatively, the parking assistance device 100, 100a and the method thereof described in the present disclosure may be realized by one or more dedicated computers configured by a combination of a processor and memory programmed to perform one or more functions, and a processor configured with one or more hardware logic circuits. In addition, the computer program may be stored in a computer-readable, non-transitory tangible storage medium as instructions to be executed by a computer.

The present disclosure can be implemented in numerous forms other than the parking assistance device, including, for example, a parking assistance method, a computer program for implementing the parking assistance device and method, and a non-transitory storage medium storing such a computer program.

The present disclosure is not limited to any of the embodiments described above but may be implemented by a diversity of other configurations without departing from the scope of the disclosure. For example, the technical features of the embodiments corresponding to the technical features of the respective aspects may be replaced or combined appropriately, in order to solve some or all of the issues described above or in order to achieve some or all of the advantages described above. Any of the technical features may be omitted appropriately unless the technical feature is described as essential herein.

What is claimed is:

1. A parking assistance device for assisting parking of a vehicle equipped with a sensor device capable of detecting surroundings, the parking assistance device comprising:
a route setting unit configured to set a target route from a current location of the vehicle to a planned parking location by using a detection result of the sensor device;
a control region setting unit configured to set, according to a location of the vehicle, a first control region and a second control region each including at least a portion positioned on a travel direction side of the vehicle, along the target route, the first control region being larger than the second control region, a center of the first control region being positioned farther from the vehicle than a center of the second control region; and
a driving control unit configured to control driving of the vehicle such that a vehicle speed of the vehicle is kept at or below a predefined threshold speed when an obstacle is detected within the first control region by the sensor device, and to control driving of the vehicle such that the vehicle is brought to a stop at a predefined deceleration when an obstacle is detected within the second control region by the sensor device;
an obstacle identification unit configured to identify, by using detection results obtained by the sensor device at different times, whether a detected obstacle is a stationary object or a moving object; and
a movement trajectory estimation unit configured to estimate a future movement trajectory of the obstacle identified as the moving object, wherein
the control region setting unit is further configured to set an expected first control region and an expected second control region that are respectively the first control region and the second control region immediately after a predefined time has elapsed, and
the driving control unit is further configured to control driving of the vehicle such that the vehicle speed of the vehicle is kept at or below the predefined threshold speed when the future movement trajectory intersects the expected first control region, and to control driving of the vehicle such that the vehicle is brought to a stop at the predefined deceleration when the future movement trajectory intersects the expected second control region.

2. The parking assistance device according to claim 1, wherein
each of the first control region and the second control region is a rectangular region having a long side in a longitudinal direction of the vehicle and a short side in a lateral direction of the vehicle, and is set as a region including the vehicle, and
a length along the target route from a front end of the second control region in a travel direction of the vehicle to a front end of the vehicle in the travel direction is set to a length equal to or greater than a braking distance during travel along the target route at a predefined maximum speed.

3. The parking assistance device according to claim 1, wherein
the driving control unit is further configured to, when, after the obstacle is detected within the first control region, the obstacle is subsequently detected outside the first control region, cease controlling driving of the vehicle such that the vehicle speed of the vehicle is kept at or below the threshold speed.

4. The parking assistance device according to claim 2, wherein
the driving control unit is further configured to, when, after the obstacle is detected within the first control region, the obstacle is subsequently detected outside the first control region, cease controlling driving of the vehicle such that the vehicle speed of the vehicle is kept at or below the threshold speed.

5. The parking assistance device according to claim 1, wherein
the driving control unit is further configured to, when, after the obstacle is detected within the second control region, the obstacle is subsequently detected outside the second control region, continue controlling driving of the vehicle such that the vehicle is brought to a stop at the predefined deceleration.

6. The parking assistance device according to claim 2, wherein
the driving control unit is further configured to, when, after the obstacle is detected within the second control region, the obstacle is subsequently detected outside the second control region, continue controlling driving of the vehicle such that the vehicle is brought to a stop at the predefined deceleration.

7. A parking assistance method for a parking assistance device to assist parking of a vehicle equipped with a sensor device capable of detecting surroundings, the parking assistance method comprising steps of:
the parking assistance device setting a target route from a current location of the vehicle to a planned parking location by using a detection result of the sensor device;
the parking assistance device setting, according to a location of the vehicle, a first control region and a second control region each including at least a portion positioned on a travel direction side of the vehicle, along the target route, the first control region being larger than the second control region, a center of the first control region being positioned farther from the vehicle than a center of the second control region; and
the parking assistance device controlling driving of the vehicle;
the parking assistance device identifying, by using detection results obtained by the sensor device at different times, whether a detected obstacle is a stationary object or a moving object; and
the parking assistance device estimating a future movement trajectory of the obstacle identified as the moving object, wherein
the step of the parking assistance device setting the first control region and the second control region further includes setting an expected first control region and an expected second control region that are respectively the first control region and the second control region immediately after a predefined time has elapsed; and
the step of the parking assistance device controlling driving of the vehicle further includes:
controlling driving of the vehicle such that a vehicle speed of the vehicle is kept at or below a predefined threshold speed when an obstacle is detected within the first control region by the sensor device;
controlling driving of the vehicle such that the vehicle is brought to a stop at a predefined deceleration when an obstacle is detected within the second control region by the sensor device;
controlling driving of the vehicle such that the vehicle speed of the vehicle is kept at or below the predefined threshold speed when the future movement trajectory intersects the expected first control region; and
controlling driving of the vehicle such that the vehicle is brought to a stop at the predefined deceleration when the future movement trajectory intersects the expected second control region.

8. A computer program product for assisting parking of a vehicle equipped with a sensor device capable of detecting surroundings, the computer program product comprises a non-transitory computer readable storage medium having computer readable program stored therein, the computer readable program configured to cause a computer to implement functions of:
setting a target route from a current location of the vehicle to a planned parking location by using a detection result of the sensor device;
setting, according to a location of the vehicle, a first control region and a second control region each including at least a portion positioned on a travel direction side of the vehicle, along the target route, the first control region being larger than the second control region, a center of the first control region being positioned farther from the vehicle than a center of the second control region; and
controlling driving of the vehicle;
identifying, by using detection results obtained by the sensor device at different times, whether a detected obstacle is a stationary object or a moving object; and
estimating a future movement trajectory of the obstacle identified as the moving object, wherein
the function of setting the first control region and the second control region further includes setting an expected first control region and an expected second control region that are respectively the first control region and the second control region immediately after a predefined time has elapsed; and
the function of controlling driving of the vehicle further includes:
controlling driving of the vehicle such that a vehicle speed of the vehicle is kept at or below a predefined threshold speed when an obstacle is detected within the first control region by the sensor device;
controlling driving of the vehicle such that the vehicle is brought to a stop at a predefined deceleration when an obstacle is detected within the second control region by the sensor device;
controlling driving of the vehicle such that the vehicle speed of the vehicle is kept at or below the predefined threshold speed when the future movement trajectory intersects the expected first control region; and
controlling driving of the vehicle such that the vehicle is brought to a stop at the predefined deceleration when the future movement trajectory intersects the expected second control region.
